(19) United States
(12) Patent Application Publication
(10) Pub. No.: US 2026/0162458 A1
(43) Pub. Date: Jun. 11, 2026

(54) INFORMATION PROCESSING APPARATUS AND CONTROL METHOD

(71) Applicant: Lenovo (Singapore) Pte. Ltd., Singapore (SG)

(72) Inventor: Masashi Nishio, Kanagawa (JP)

(73) Assignee: Lenovo (Singapore) Pte. Ltd., Singapore (SG)

(21) Appl. No.: 19/179,026

(22) Filed: Apr. 15, 2025

(30) Foreign Application Priority Data
Apr. 24, 2024 (JP) 2024-070601

(51) Int. Cl. G06V 40/16; G09G 5/10

(52) U.S. Cl. CPC G06V 40/172; G06V 40/161; G09G 5/10; G09G 2320/0626; G09G 2330/021

(57) ABSTRACT

An information processing apparatus includes a first processor which controls the operation of the system, and a second processor which performs detection processing to detect a person present in a direction to face a display unit and to detect whether or not the person is paying attention to the display unit based on a captured image, and face authentication processing to check a face image of the person with a face image of a user registered in advance, wherein when the presence of the person paying attention to the display unit is no longer detected from the detected state, a transition to a low power mode is made, and after that, in a case where the presence of a person paying attention to the display unit is detected, when the person is determined to be the user registered in advance, the power mode is restored from low power mode.

### CROSS-REFERENCE TO RELATED APPLICATIONS

This application claims priority to Japanese Patent Application No. 2024-070601 filed on Apr. 24, 2024, the contents of which are hereby incorporated herein by reference in their entirety.

### Technical Field

The present invention relates to an information processing apparatus and a control method.

### BACKGROUND

For example, in Japanese Unexamined Patent Application Publication No. 2020-102151, it is disclosed a PC (personal computer) for detecting that a person has approached or has moved away using an infrared sensor to boot a system by detecting that the person has approached and to turn off the display and make a transition to a standby state by detecting that the person has moved away. In the standby state, not only is power consumption reduced by turning off the display, but also security is ensured by locking the system.

Further, in recent years, with the development of computer vision and the like, detection accuracy when detecting a face from an image has been getting higher. Therefore, a person is also detected by detecting a face from a captured image instead of the detection of the person by the infrared sensor. In the person detection by face detection, since the orientation of a face can also be detected in addition to simply detecting a person, control according to the orientation of the face can also be performed. For example, when the face orientation is not facing forward (the direction of the screen), control is performed to reduce the screen brightness of a display unit in order to save power.

For example, when reducing the screen brightness to save power in a case where the face is facing sideways, since control is only to adjust the brightness, the screen brightness can be restored immediately when the face is turned to the front again. On the other hand, in a case where the system is locked when the person has moved away and becomes absent, since user authentication is required to unlock the system next time to use the PC, it takes time. Therefore, although it does not matter about power saving when the face is turned sideways is determined in a short period of time because the screen brightness can be restored immediately, there is a demand not to lock the system in the absence of a person for a short period of time. However, if the time from when the absence of a person is detected until the system is locked is lengthened, there will be concern about security during the time.

### SUMMARY

Embodiments of the present invention provide an information processing apparatus and a control method for controlling not to lock a system in the absence of a person for a short period of time while ensuring security when locking the system due to the absence of the person.

In accordance with one or more embodiments, an information processing apparatus includes: a memory which temporarily stores a program of a system; a first processor which controls the operation of the system by executing the program of the system; and a second processor which performs detection processing to detect a person present in a direction to face a display unit and to detect whether or not the person is paying attention to the display unit based on a captured image captured by an imaging unit, and face authentication processing to check a face image of the person present in the direction to face the display unit with a face image of a user registered in advance, wherein the first processor performs power reduction processing in which, when the presence of the person paying attention to the display unit is no longer detected from a state where the presence of the person is detected by the detection processing, the first processor makes a transition to a low power mode, determination processing in which, after the transition to the low power mode, when the presence of a person paying attention to the display unit is detected by the detection processing, the first processor determines whether or not the person is the user registered in advance based on an authentication result by the face authentication processing, power restoration processing in which, when the presence of the person paying attention to the display unit is detected by the detection processing and the person is determined to be the user registered in advance by the determination processing after the transition to the low power mode, the first processor restores a power mode from the low power mode, and lock processing in which, when the presence of the person paying attention to the display unit is detected by the detection processing and the person is determined not to be the user registered in advance by the determination processing after the transition to the low power mode, the first processor locks the system.

The above information processing apparatus may be such that, after locking the system, the first processor performs unlock processing to unlock the system on a condition that an authentication result by system authentication processing to authenticate whether or not the person is an authorized user registered in advance in the system is authentication success.

The above information processing apparatus may also be such that in the lock processing, in a case where the presence of the person paying attention to the display unit is no longer detected in the direction to face the display unit from the state where the presence of the person is detected by the detection processing, when a first time has passed in a state where the presence of the person is not detected, the first processor locks the system, and after the transition to the low power mode, when the presence of a person paying attention to the display unit is detected by the detection processing and the person is determined not to be the user registered in advance by the determination processing, the first processor locks the system according to the fact that the detection and the determination are made without waiting for the first time to pass.

The above information processing apparatus may further be such that, in the power reduction processing, in a case where the presence of the person paying attention to the display unit is no longer detected from the state where the presence of the person is detected by the detection processing, when a second time shorter than the first time has passed in the state where the presence of the person paying attention to the display unit is not detected, the first processor makes the transition to the low power mode.

Further, the above information processing apparatus may be such that, in the lock processing, when a third time has passed in a state where input by the user is not detected regardless of the transition to the low power mode, the first processor locks the system, and when the presence of a person paying attention to the display unit is detected by the detection processing and the person is determined not to be the user registered in advance by the determination processing after the transition to the low power mode, the first processor locks the system according to the fact that the detection and the determination are made without waiting for the third time to pass.

Further, the above information processing apparatus may be such that, in the power reduction processing, in the case where the presence of the person paying attention to the display unit is no longer detected from the state where the presence of the person is detected by the detection processing, when a second time shorter than the third time has passed in the state where the person paying attention to the display unit is not detected, the first processor makes the transition to the low power mode.

Further, the above information processing apparatus may be such that the low power mode is an operating mode in which the screen brightness of the display unit is reduced.

In accordance with one or more embodiments, an information processing apparatus includes: a memory which temporarily stores a program of a system; a first processor which controls the operation of the system by executing the program of the system; and a second processor which performs detection processing to detect a person present in a direction to face a display unit based on captured images captured by an imaging unit, wherein the second processor performs first face authentication processing to check a first face image of the person present in the direction to face the display unit with a face image for first authentication of a user registered in advance, and the first processor performs lock processing to lock the system when the presence of the person is detected in the direction to face the display unit by the detection processing and the person is determined not to be the user registered in advance by the first face authentication processing, second face authentication processing to check a second face image of the person present in the direction to face the display unit, acquired based on a captured image captured by the imaging unit under a condition different from that of the first face image, with a face image for second authentication of the user registered in advance, and unlock processing to unlock the system when the person is determined to be the user registered in advance by the second face authentication processing.

Further, a control method for an information processing apparatus according to one or more embodiments includes: a memory which temporarily stores a program of a system; a first processor which controls the operation of the system by executing the program of the system; and a second processor which performs detection processing to detect a person present in a direction to face a display unit and to detect whether or not the person is paying attention to the display unit based on a captured image captured by an imaging unit, and face authentication processing to check a face image of the person present in the direction to face the display unit with a face image of a user registered in advance, the control method causing the first processor to perform a step of making a transition to a low power mode when the presence of the person paying attention to the display unit is no longer detected from a state where the presence of the person is detected by the detection processing, a step of determining whether or not a person paying attention to the display unit is a user registered in advance based on an authentication result by the face authentication processing when the person is detected by the detection processing after the transition to the low power mode, a step of restoring a power mode from the low power mode when the presence of the person paying attention to the display unit is detected by the detection processing and the person is determined to be the user registered in advance after the transition to the low power mode, and a step of locking the system when the presence of the person paying attention to the display unit is detected by the detection processing and the person is determined not to be the user registered in advance after the transition to the low power mode.

Further, a control method for an information processing apparatus according to one or more embodiments includes: a memory which temporarily stores a program of a system; a first processor which controls the operation of the system by executing the program of the system; and a second processor which performs detection processing to detect a person present in a direction to face a display unit based on captured images captured by an imaging unit, the control method including: a first face authentication step of causing the second processor to check a first face image of the person present in the direction to face the display unit with a face image for first authentication of a user registered in advance; a step of causing the first processor to lock the system when the presence of the person is detected in the direction to face the display unit by the detection processing, and the person is determined not to be the user registered in advance by the first face authentication step; a second face authentication step of causing the first processor to check a second face image of the person present in the direction to face the display unit, acquired based on a captured image captured by the imaging unit under a condition different from that of the first face image, with a face image for second authentication of the user registered in advance; and a step of causing the first processor to unlock the system when the person is determined to be the user registered in advance by the second face authentication step.

Embodiments of the present disclosure can control a system not to lock the system in the absence of a person for a short period of time while ensuring security when locking the system in response to the absence of the person.

### BRIEF DESCRIPTION OF THE DRAWINGS

FIG. 1 is a perspective view illustrating a configuration example of the appearance of an information processing apparatus according to one or more embodiments.

FIG. 2 is a diagram illustrating an example of a person detection range of the information processing apparatus according to one or more embodiments.

FIGS. 3A-3C are diagrams for describing an overview of HPD processing of the information processing apparatus according to one or more embodiments.

FIG. 4 is a schematic diagram for describing screen brightness control depending on a face orientation according to one or more embodiments.

FIG. 5 is a table illustrating the contrast between screen brightness reduction processing and system lock processing according to one or more embodiments.

FIG. 6 is a diagram illustrating an overview of processing when a screen brightness is restored from a low brightness according to one or more embodiments.

FIG. 7 is a schematic block diagram illustrating an example of the hardware configuration of the information processing apparatus according to one or more embodiments.

FIG. 8 is a schematic block diagram illustrating an example of the functional configuration of the information processing apparatus according to one or more embodiments.

FIG. 9 is a flowchart illustrating an example of the screen brightness reduction processing and the system lock processing according to one or more embodiments.

### DETAILED DESCRIPTION

Embodiments of the present invention will be described below with reference to the accompanying drawings.

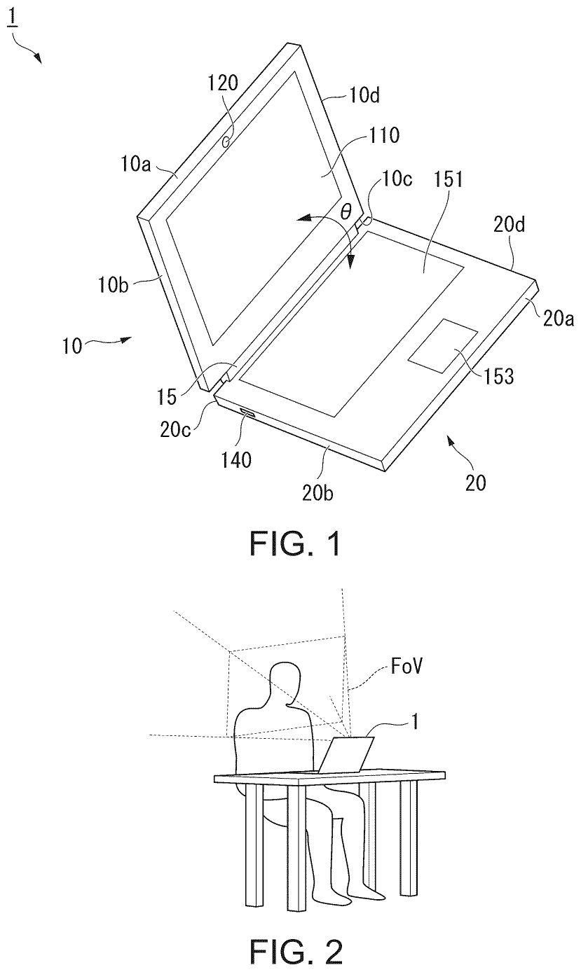

FIG. 1 is a perspective view illustrating a configuration example of the appearance of an information processing apparatus 1 according to one or more embodiments.

The information processing apparatus 1 is, for example, a laptop (clamshell) PC (Personal Computer). The information processing apparatus 1 includes a first chassis 10, a second chassis 20, and a hinge mechanism 15. The first chassis 10 and the second chassis 20 are coupled by using the hinge mechanism 15. The first chassis 10 is rotatable around an axis of rotation formed by the hinge mechanism 15 relative to the second chassis 20. An open angle by the rotation between the first chassis 10 and the second chassis 20 is denoted by “θ” in FIG. 1.

The first chassis 10 is also called A cover or a display chassis. The second chassis 20 is also called C cover or a system chassis. In the following description, side faces on which the hinge mechanism 15 is provided among side faces of the first chassis 10 and the second chassis 20 are referred to as side faces 10c and 20c, respectively. Among the side faces of the first chassis 10 and the second chassis 20, faces opposite to the side faces 10c and 20c are referred to as side faces 10a and 20a, respectively. In this figure, the direction from the side face 20a toward the side face 20c is referred to as “rear,” and the direction from the side face 20c toward the side face 20a is referred to as “front.” The right side and the left side in the rearward direction are referred to as “right” and “left,” respectively. Left side faces of the first chassis 10 and the second chassis 20 are referred to as side faces 10b and 20b, respectively, and right side faces thereof are referred to as side faces 10d and 20d, respectively. Further, a state where the first chassis 10 and the second chassis 20 overlap each other and are completely closed (a state of open angle θ=0°) is referred to as a “closed state.” Surfaces of the first chassis 10 and the second chassis 20 on the face-to-face sides in the closed state are referred to as respective “inner surfaces,” and surfaces opposite to the inner surfaces are referred to as “outer surfaces.” Further, a state opposite to the closed state, where the first chassis 10 and the second chassis 20 are open, is referred to as an “open state.”

The appearance of the information processing apparatus 1 in FIG. 1 illustrates an example of the open state. The open state is a state where the side face 10a of the first chassis 10 and the side face 20a of the second chassis 20 are separated. In the open state, the respective inner surfaces of the first chassis 10 and the second chassis 20 appear. The open state is one of the states where a user uses the information processing apparatus 1, and the information processing apparatus 1 is often used in a state where the open angle is typically about θ=100° to 130°. Note that the range of open angles θ to be the open state can be set arbitrarily according to the range of angles rotatable by the hinge mechanism 15 or the like.

A display unit 110 is provided on the inner surface of the first chassis 10. The display unit 110 is configured to include a liquid crystal display (LCD) or an organic EL (Electro Luminescence) display, and the like. Further, an imaging unit 120 is provided in a peripheral area of the display unit 110 on the inner surface of the first chassis 10. For example, the imaging unit 120 is arranged on the side of the side face 10a in the peripheral area of the display unit 110. Note that the position at which the imaging unit 120 is arranged is just an example, and it may be elsewhere as long as the imaging unit 120 can be directed in a direction to face a display screen of the display unit 110.

In the open state, the imaging unit 120 images a predetermined imaging range in the direction to face the display screen of the display unit 110 (that is, in front of the information processing apparatus 1). The predetermined imaging range is a range of angles of view defined by an image sensor included in the imaging unit 120 and an optical lens provided in front of the imaging surface of the image sensor. For example, the imaging unit 120 can capture an image including a person (user) present in front of (on the front side of) the information processing apparatus 1.

Further, a power button 140 is provided on the side face 20b of the second chassis 20. The power button 140 is an operating element used by the user to give an instruction to power on or power off, make a transition from a standby state to a normal operating state, make a transition from the normal operating state to the standby state, or the like. The normal operating state is an operating state of a system capable of executing processing without being particularly limited, which corresponds, for example, to S0 state defined in the ACPI (Advanced Configuration and Power Interface) specification.

The standby state is a state in which at least part of system processing is limited, and the power consumption is lower than that in the normal operating state. For example, the standby state is such a state that the display of the display unit 110 is turned off (the screen is turned off) and the system is locked, which may be the standby state or a sleep state, Modern Standby in Windows (registered trademark), or a state corresponding to S3 state (sleep state) defined in the ACPI specification. The state where the system is locked is an unusable state unless the system is unlocked, and system user authentication is required to unlock the system.

Further, a keyboard 151 and a touch pad 153 are provided on the inner surface of the second chassis 20 as an input device to accept user operation input. Note that a touch sensor may also be provided as the input device instead of or in addition to the keyboard 151 and the touch pad 153, or a mouse and an external keyboard may be connected. When the touch sensor is provided, an area corresponding to the display screen of the display unit 110 may be constructed as a touch panel to accept operations. Further, a microphone used to input voice may be included in the input device.

Note that in the closed state where the first chassis 10 and the second chassis 20 are closed, the display unit 110 and the imaging unit 120 provided on the inner surface of the first chassis 10, and the keyboard 151 and the touch pad 153 provided on the inner surface of the second chassis 20 are covered with each other's chassis surfaces, and put in a state of being disabled from fulfilling the functions.

The information processing apparatus 1 executes HPD (Human Presence Detection) processing to detect a person present in front of the information processing apparatus 1 based on a captured image captured by the imaging unit 120.

FIG. 2 is a diagram illustrating an example of a person detection range of the information processing apparatus 1 according to one or more embodiments. In the illustrated example, a detection range FoV (Field of View: detection viewing angle) in front of the information processing apparatus 1 is a person-detectable range.

For example, the information processing apparatus 1 detects a face area with a face captured therein from a captured image captured by the imaging unit 120 to determine whether or not a person (user) is present in front of the information processing apparatus 1. The detection range FoV corresponds to an imaging angle of view at which the information processing apparatus 1 captures images. Note that the detection range FoV may be narrower than the imaging angle of view of the imaging unit 120. When the face area is detected from the captured image, the information processing apparatus 1 determines that a person is present. On the other hand, when no face area is detected from the captured image, the information processing apparatus 1 determines that no person is present.

The information processing apparatus 1 controls the operating state of the system of the information processing apparatus 1 depending on the presence or absence of a person by the HPD processing. For example, when a person is present in front of the information processing apparatus 1, the information processing apparatus 1 controls the operating state to the normal operating state, while when no person is present in front of the information processing apparatus 1, the information processing apparatus 1 makes the transition to the standby state to lock the system.

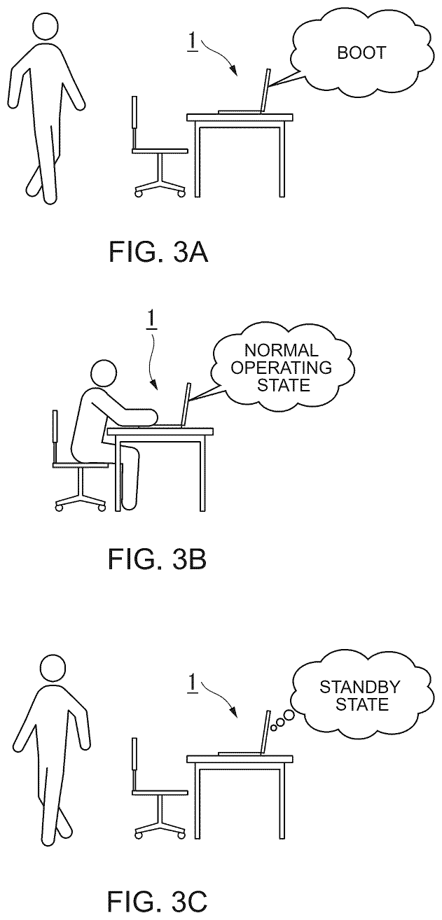

FIG. 3 is a diagram for describing an overview of HPD processing of the information processing apparatus 1 according to one or more embodiments. The information processing apparatus 1 detects a person present in front of the information processing apparatus 1 by the HPD processing to control the operating state of the system of the information processing apparatus 1 based on the presence or absence of a person. For example, as illustrated in FIG. 3A, when detecting a change from a state where no person is present in front of the information processing apparatus 1 (No presence) to a state where a person is present (Presence) in the standby state, that is, when detecting that a person has approached the information processing apparatus 1 (Approach), the information processing apparatus 1 automatically boots the system to make the transition to the normal operating state. Further, in a state where a person is present in front of the information processing apparatus 1 (Presence) in the normal operating state as illustrated in FIG. 3B, the information processing apparatus 1 continues the normal operating state. Further, as illustrated in FIG. 3C, when detecting a change from the state where the person is present in front of the information processing apparatus 1 (Presence) to the state where no person is present (No presence), that is, when detecting that the person has left the information processing apparatus 1 (Leave), the information processing apparatus 1 causes the system to make the transition to the standby state and locks the system.

Further, in the HPD processing, the information processing apparatus 1 detects the orientation of a face of the person present in front of the information processing apparatus 1. The orientation of the face here is an orientation corresponding to a rotation angle of the face in the left and right direction and the up and down direction. In the following, it is assumed that a state where the face is facing the direction of the information processing apparatus 1 (the direction of the display unit 110 and the imaging unit 120) is a state where the orientation of the face is front facing.

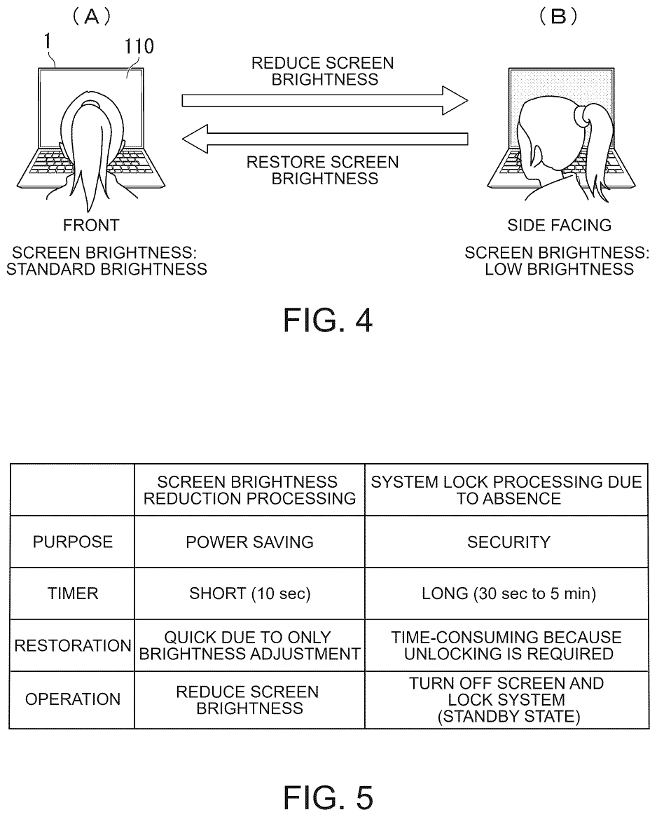

FIG. 4 is a schematic diagram for describing screen brightness control depending on the face orientation according to one or more embodiments. As illustrated in FIG. 4, the information processing apparatus 1 performs processing to reduce the screen brightness of the display unit 110 depending on the orientation of the face of the person (user) (screen brightness reduction processing). Specifically, when the orientation of the face is not front facing (for example, when the orientation of the face is turned to side facing) as illustrated in FIG. 4 panel (B), unlike when the orientation of the face is front facing as illustrated in FIG. 4 panel (A), the information processing apparatus 1 reduces the screen brightness of the display unit 110. Since the reduction in screen brightness is intended to save power, it can also be called a transition to a low power mode. Further, when the orientation of the face is turned to front facing again, the information processing apparatus 1 restores the screen brightness to the original screen brightness before being reduced.

Here, the original screen brightness before being reduced is, for example, the screen brightness when the system is in the normal operating state, which is a screen brightness based on a brightness setting value initially set in the system or a brightness setting value changed by the user from the initially-set brightness setting value. In the following, the screen brightness based on this brightness setting value initially set or a brightness setting value changed by the user from the initially-set brightness setting value is called “standard brightness.” On the other hand, the screen brightness reduced from the standard brightness is called “low brightness.” The low brightness is a brightness at least lower than the standard brightness. However, the lower the brightness, the more the effect of power saving will increase. The brightness setting value of the low brightness is preset, which is set, for example, to about 0 to 10% of the value of the standard brightness. The brightness of 0% is equivalent to a screen-off state in appearance. Note that the case where the orientation of the face is not facing forward is not limited to the case where the face is facing sideways, and a case where the orientation of the face is turned to up, down, or back facing is also included.

Further, the state where the face is facing forward is called “Attention” because it is a state of paying attention to the display screen of the display unit 110 of the information processing apparatus 1. On the other hand, the state where the face is not facing forward is called “No attention” because it is a state of not paying attention to the display screen of the display unit 110 of the information processing apparatus 1.

For example, in the case of a change from “Attention” to “No attention,” the information processing apparatus 1 changes the screen brightness of the display unit 110 from the standard brightness to the low brightness (makes the transition to the low power mode). Further, in the case of a change to “No presence” (that is, when “Leave” is detected), since the state of “Attention” is also changed to the state of “No attention,” the information processing apparatus 1 first changes the screen brightness of the display unit 110 from the standard brightness to the low brightness (makes the transition to the low power mode), and then makes the transition to the standby state after a predetermined time has passed to turn off the screen and lock the system. Thus, when the user is not paying attention to the display screen of the display unit 110 or when the user is absent, the information processing apparatus 1 reduces the screen brightness of the display unit 110 to the low brightness to save power, and when the predetermined time has passed while the user is absent, the information processing apparatus 1 locks the system to ensure security.

Referring here to FIG. 5, screen brightness reduction processing performed by the information processing apparatus 1 due to the orientation of a face of a person and the absence of the person is contrasted with system lock processing performed due to the continued absence of the person. FIG. 5 is a table illustrating the contrast between the screen brightness reduction processing and the system lock processing. As described above, the screen brightness reduction processing is processing for the purpose of power saving, where operation to reduce the screen brightness is performed. Since the screen brightness reduction processing is only to adjust the brightness, restoration after reducing the screen brightness is quick. Therefore, the time (timer) from when “No attention” (or “No presence”) is detected until the screen brightness is reduced is set relatively short (for example, 10 seconds).

On the other hand, the system lock processing is processing for the purpose of security as described above, where operation to turn off the screen and lock the system is performed. Since the system lock processing is required to unlock the system upon restoration, it takes time. If the system is locked easily in the absence for a short period of time, since it will take time to unlock the system each time, the time (timer) from when “No presence” is detected until the system is locked is often set relatively long (for example, about 30 seconds to 5 minutes) not to lock the system in the absence for a very short period of time.

However, when the time during which the system is not being locked is too long, there is concern about security during the time though power is saved by reducing the screen brightness due to the absence. For example, when the time during which the system is not being locked is too long in the absence, concerns about being accessed by persons other than an authorized user during the time grow.

Therefore, in a case where “Attention” is detected in a period during which the screen brightness is being reduced due to the fact that “No attention” (or “No presence”) was detected, the information processing apparatus 1 according to one or more embodiments restores the screen brightness to the standard brightness only when the person is a registered user (that is, the authorized user), and when the person is not the registered user, the information processing apparatus 1 locks the system instantly to disable the use of the system until the system is unlocked by user authentication or the like.

FIG. 6 is a diagram illustrating an overview of processing when the screen brightness is restored from the low brightness according to one or more embodiments. (1) When “No attention” is detected from a state of detecting “Attention,” (2) the information processing apparatus 1 changes the screen brightness of the display unit 110 from the standard brightness to the low brightness. (3) When “Attention” is detected in a state where the screen brightness is the low brightness (a state where “No attention” is being detected), (4) the information processing apparatus 1 determines whether or not the person is the registered user. (5) When determining that the person is the registered user (YES), the information processing apparatus 1 restores the screen brightness to the standard brightness. (6) On the other hand, when determining that the person is an unregistered user (NO), the information processing apparatus 1 turns off the screen and locks the system.

Thus, when an unregistered user is detected before locking the system after reducing the screen brightness due to the fact that the user is not paying attention to the display screen or that the user becomes absent, the information processing apparatus 1 locks the system instantly. Therefore, the information processing apparatus 1 can realize both power saving and security ensuring in the case of absence for a short period of time.

Thus, even when the time (timer) from when the absence of a person is detected until the system is locked is set long not to lock the system in the absence for the short period of time (not to take much time to unlock the system for use), the information processing apparatus 1 ensures security until the system is locked. Therefore, the information processing apparatus 1 can control the system not to lock the system in the absence of the person for the short period of time while ensuring security.

The configurations of the information processing apparatus 1 according to one or more embodiments will be described in detail below.

### Hardware Configuration of Information Processing Apparatus

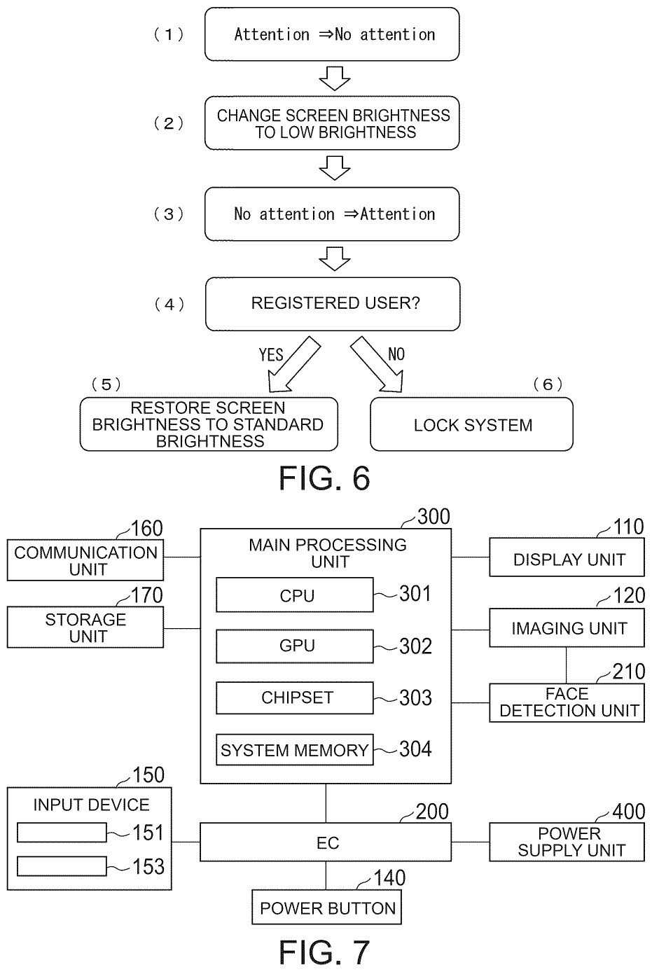

FIG. 7 is a schematic block diagram illustrating an example of the hardware configuration of the information processing apparatus 1 according to one or more embodiments. In FIG. 7, components corresponding to respective units in FIG. 1 are given the same reference numerals. The information processing apparatus 1 is configured to include the display unit 110, the imaging unit 120, the power button 140, an input device 150, a communication unit 160, a storage unit 170, an EC (Embedded Controller) 200, a face detection unit 210, a main processing unit 300, and a power supply unit 400.

The display unit 110 displays display data (images) generated based on system processing executed by the main processing unit 300, processing of an application program(s) running on the system processing, and the like.

The imaging unit 120 captures an image of an object within the predetermined imaging range (angle of view) in the direction (frontward) to face the inner surface of the first chassis 10, and outputs the captured image to the main processing unit 300 and the face detection unit 210. For example, the imaging unit 120 includes a visible light camera (RGB camera) for capturing an image using visible light and an infrared camera (IR camera) for capturing an image using infrared light.

Note that the imaging unit 120 may be configured to include either one of the visible light camera and the infrared camera, or may be configured to include both of the visible light camera and the infrared camera.

The power button 140 outputs, to the EC 200, an operation signal according to a user operation. The input device 150 is an input unit for accepting user input, which is configured to include, for example, the keyboard 151 and the touch pad 153. In response to accepting operations on the keyboard 151 and the touch pad 153, the input device 150 outputs, to the EC 200, operation signals indicative of operation contents.

The communication unit 160 is connected to other devices communicably through a wireless or wired communication network to transmit and receive various data. For example, the communication unit 160 is configured to include a wired LAN interface such as Ethernet (registered trademark), a wireless LAN interface such as Wi-Fi (registered trademark), and the like.

The storage unit 170 is configured to include storage media, such as an HDD (Hard Disk Drive) or an SSD (Solid State Drive), a RAM (Random Access Memory), and a ROM (Read Only Memory). The storage unit 170 stores an OS, device drivers, various programs such as applications, and various data acquired by the operation of the programs.

The power supply unit 400 supplies power to each unit according to the operating state of each unit of the information processing apparatus 1. The power supply unit 400 includes a DC(Direct Current)/DC converter. The DC/DC converter converts the voltage of DC power, supplied from an AC (Alternate Current)/DC adapter or a battery (battery pack), to a voltage required for each unit. The power with the voltage converted by the DC/DC converter is supplied to each unit through each power system. For example, the power supply unit 400 supplies power to each unit through each power system based on a control signal input from the EC 200.

The EC 200 is a microcomputer configured to include a CPU (Central Processing Unit), a RAM (Random Access Memory), a ROM (Read Only Memory), an I/O (Input/Output) logic circuit, and the like. The CPU of the EC 200 reads a control program (firmware) prestored in the own ROM, and executes the read control program to fulfill the functionality. The EC 200 operates independently of the main system processing unit 300 to control the operation of the main processing unit 300 and manage the operating state of the main processing unit 300. Further, the EC 200 is connected to the power button 140, the input device 150, the power supply unit 400, and the like.

For example, the EC 200 communicates with the power supply unit 400 to acquire information on a battery state (remaining battery capacity, and the like) from the power supply unit 400 and to output, to the power supply unit 400, a control signal or the like in order to control the supply of power according to the operating state of each unit of the information processing apparatus 1. Further, the EC 200 acquires operation signals from the power button 140 and the input device 150, and outputs, to the main processing unit 300, an operation signal related to processing of the main processing unit 300 among the acquired operation signals.

The face detection unit 210 is configured to include a processor to execute the HPD processing by face detection based on image data of a captured image captured by the imaging unit 120. The face detection unit 210 acquires the image data of the captured image captured by the imaging unit 120, and temporarily stores the acquired image data in a memory. The memory in which the image data is stored may be a system memory 304, or an unillustrated memory in the face detection unit 210.

For example, the face detection unit 210 processes the image data of the captured image acquired from the imaging unit 120 to perform face detection processing to detect a face area from the captured image, the orientation of a face of a face image included in the detected face area, and the like. As the face detection method, any detection method using a face detection algorithm for detecting a face based on facial feature information, trained data (learned model) subjected to machine learning based on the facial feature information, a face detection library, or the like can be applied.

The main processing unit 300 is configured to include a CPU (Central Processing Unit) 301, a GPU (Graphic Processing Unit) 302, a chipset 303, and the system memory 304, where processing of various application programs is executable on the OS (Operating System) by system processing based on the OS.

The CPU 301 is a processor which executes processing based on a BIOS program, processing based on the OS program, processing based on application programs running on the OS, and the like. For example, the CPU 301 executes boot processing to boot the system from the standby state and make the transition to the normal operating state, sleep processing to make the transition from the normal operating state to the standby state, and the like.

The GPU 302 is connected to the display unit 110. The GPU 302 executes image processing under the control of the CPU 301 to generate display data. The GPU 302 outputs the generated display data to the display unit 110.

The chipset 303 has a function as a memory controller, a function as an I/O controller, and the like. For example, the chipset 303 controls reading data from and writing data to the system memory 304, the storage unit 170, and the like by the CPU 301 and the GPU 302. Further, the chipset 303 controls input/output of data from the communication unit 160, the display unit 110, and the EC 200. Further, the chipset 303 has a function as a sensor hub. For example, the chipset 303 acquires the detection results by the face detection processing from the face detection unit 210, and outputs the detection results to the CPU 301.

The system memory 304 is used as a reading area of a program executed by the CPU 301 and a working area to write processed data. Further, the system memory 304 temporarily stores image data of a captured image captured by the imaging unit 120.

Note that the CPU 301, the GPU 302, and the chipset 303 may be integrated as one processor, or some or each of them may be configured as an individual processor, respectively. For example, in the normal operating state, the CPU 301, the GPU 302, and the chipset 303 are all operating, but in the standby state, only at least part of the chipset 303 is operating.

[Functional Configuration of Information Processing Apparatus]

Next, the functional configuration of the information processing apparatus 1 to perform screen brightness control of the display unit 110 by the HPD processing will be described in detail.

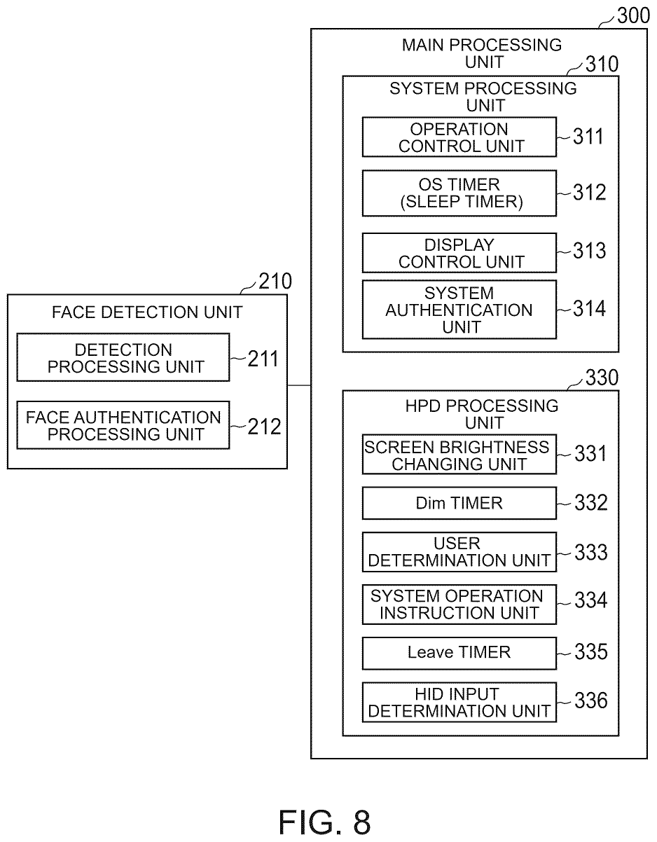

FIG. 8 is a schematic block diagram illustrating an example of the functional configuration of the information processing apparatus 1 according to one or more embodiments. The information processing apparatus 1 includes the face detection unit 210 and the main processing unit 300. The face detection unit 210 corresponds to the face detection unit 210 illustrated in FIG. 7, which is a functional component implemented by executing a program in the face detection unit 210. The main processing unit 300 corresponds to the main processing unit 300 illustrated in FIG. 7, which includes a system processing unit 310 and an HPD processing unit 330. The system processing unit 310 and the HPD processing unit 330 are functional components implemented by the main processing unit 300 executing the OS and a program running on the OS. For example, the system processing unit 310 is a functional component implemented by the CPU 301 executing the OS program.

The face detection unit 210 includes a detection processing unit 211 and a face authentication processing unit 212. The detection processing unit 211 processes image data of a captured image acquired from the imaging unit 120 to detect a face area with a face captured therein from the captured image. For example, the detection processing unit 211 reads, from the system memory 304, image data of the captured image captured by the imaging unit 120 at a predetermined frame rate (a predetermined frequency) to detect a face area from the captured image. As the face detection method, any detection method using a face detection algorithm for detecting a face based on facial feature information, trained data (learned model) subjected to machine learning based on the facial feature information, a face detection library, or the like can be applied.

For example, the detection processing unit 211 detects a face area from a captured image (RGB image) captured by using the RGB camera of the imaging unit 120 when performing the HPD processing, and outputs coordinate information on the face area as the detection result.

Further, when the face area is detected from the captured image in the HPD processing, the detection processing unit 211 outputs “Presence” information indicating that a person is present in front of the information processing apparatus 1. On the other hand, when any face area is not detected from the captured image, the detection processing unit 211 outputs “No presence” information indicating that no person is present in front of the information processing apparatus 1.

Further, when the face area is detected from the captured image, the detection processing unit 211 detects the orientation of a face of the face image included in the detected face area. For example, the detection processing unit 211 detects an orientation corresponding to the rotation angle of the face in the left-and-right direction and an orientation corresponding to the rotation angle of the face in the up-and-down direction, and determines whether or not the orientation of the face is front facing. When determining that the orientation of the face is front facing, the detection processing unit 211 outputs “Attention” information indicating that the face is paying attention to the information processing apparatus 1. On the other hand, when determining that the orientation of the face is not front facing, the detection processing unit 211 outputs “No attention” information indicating that the face is not paying attention to the information processing apparatus 1.

The face authentication processing unit 212 executes face authentication processing to check the face image in the detected face area with a face image of the authorized user. For example, the face authentication processing unit 212 performs face authentication processing (first face authentication processing) by checking a face image (first face image), detected from a captured image (RGB image) captured by using the RGB camera of the imaging unit 120 in the HPD processing, with a face image (a face image for first authentication) of the authorized user registered as a user ID in the HPD processing.

This first face authentication processing is used in the process of determining whether or not the person is the registered user (see (4) in FIG. 6), for example, when “Attention” is detected in the state where the screen brightness is set to the low brightness (in the state where “No attention” is detected) by the screen brightness reduction processing. The face authentication processing unit 212 outputs, to the HPD processing unit 330, the authentication result (the authentication result of the first face authentication processing) upon user authentication in the HPD processing.

Note that the face image of the authorized user registered as user information (account information) in the HPD processing is different from the face image of the authorized user registered as user information (account information) in the system. For example, the face image of the authorized user in the HPD processing is a face image detected from a captured image (RGB image), captured by using the RGB camera of the imaging unit 120, in an image registration menu for face authentication of the HPD processing.

The HPD processing unit 330 includes a screen brightness changing unit 331, a Dim timer 332, a user determination unit 333, a system operation instruction unit 334, a Leave timer 335, and an HID input determination unit 336 as functional components implemented by the CPU 301 or the chipset 303 (for example, the sensor hub) executing a program of the HPD processing.

The screen brightness changing unit 331 changes the screen brightness of the display unit 110 by the HPD processing. For example, when changing the screen brightness, the screen brightness changing unit 331 changes a brightness setting value stored in the storage unit 170. For example, when the “No attention” information or the “No presence” information is acquired from the face detection unit 210 in a state where the screen brightness of the display unit 110 is controlled to the standard brightness, the screen brightness changing unit 331 uses the Dim timer 332 to start counting time TD until the screen brightness is reduced. Then, the screen brightness changing unit 331 changes the brightness setting value to a value of the low brightness after the time TD has passed, and executes screen brightness reduction processing to change the screen brightness from the standard brightness to the low brightness. In other words, when the presence of a person paying attention to the display unit 110 is no longer detected by the face detection unit 210 from a state where the presence of the person is detected, the screen brightness changing unit 331 makes the transition to the low power mode as an operating mode in which the screen brightness of the display unit 110 is reduced.

The Dim timer 332 is a timer for counting the time TD (for example, 10 seconds) from when the “No attention” information or the “No presence” information is acquired from the face detection unit 210 until the screen brightness changing unit 331 reduces (dims) the screen brightness of the display unit 110. For example, when the “No attention” information or the “No presence” information is acquired from the face detection unit 210, the Dim timer 332 stats counting the time TD. Further, when the counting of the time TD by the Dim timer 332 is completed, the screen brightness changing unit 331 changes the screen brightness from the standard brightness to the low brightness, and makes the transition to the low power mode.

When the “Attention” information is acquired from the face detection unit 210 after the screen brightness changing unit 331 changes the screen brightness of the display unit 110 from the standard brightness to the low brightness, the user determination unit 333 acquires, from the face detection unit 210, the authentication result by the first face authentication processing (the authentication result upon user authentication in the HPD processing), and performs determination processing to determine whether or not the person is the authorized user registered in advance based on the acquired authentication result. In other words, when the presence of the person paying attention to the display unit 110 is detected by the face detection unit 210 after the transition to the low power mode in which the screen brightness of the display unit 110 is reduced, the user determination unit 333 determines whether or not the person is the authorized user registered in advance based on the authentication result by the first face authentication processing.

When it is determined by the user determination unit 333 that the person paying attention to the display unit 110 is the authorized user registered in advance, the screen brightness changing unit 331 restore the screen brightness of the display unit 110 from the low brightness to the standard brightness to return from the low power mode.

On the other hand, when it is determined by the user determination unit 333 that the person paying attention to the display unit 110 is not the authorized user registered in advance, the system operation instruction unit 334 outputs, to the system processing unit 310, an instruction to make the transition to the standby state (a standby state transition instruction) in order to lock the system.

Further, when the “No presence” information is acquired from the face detection unit 210, the system operation instruction unit 334 uses the Leave timer 335 to start counting time TL until the system is locked. Then, when the time TL has passed in a state where the “Attention” information (or the “Presence” information) is not acquired, the system operation instruction unit 334 determines that the person has left (Leave), and outputs, to the system processing unit 310, the standby state transition instruction to lock the system. In other words, in a case where the presence of the person paying attention to the display unit 110 is no longer detected by the face detection unit 210 from the state where the presence of the person is detected, the system operation instruction unit 334 outputs, to the system processing unit 310, the standby state transition instruction to lock the system even when the time TL has passed in the state where the presence of the person is not detected. The time TL until the system is locked upon this Leave state is set longer than the time TD until the screen brightness is changed to the low brightness in the screen brightness reduction processing.

The Leave timer 335 is a timer for counting the time TL (for example, 30 seconds to 5 minutes) from when the “No presence” information is acquired from the face detection unit 210 until the system operation instruction unit 334 outputs the standby state transition instruction to the system processing unit 310 to lock the system. For example, Leave timer 335 starts counting the time TL when the “No presence” information is acquired from the face detection unit 210. Further, when the counting of the time TL by the Leave timer 335 is completed, the system operation instruction unit 334 outputs the standby state transition instruction to the system processing unit 310.

The HID input determination unit 336 determines the presence of absence of operation input to an HID (Human Interface Device) (hereinafter called “HID input”) such as to the input device 150 (for example, the keyboard 151, the touch pad 153, and the like). For example, when there is no HID input, the HPD processing unit 330 enables and executes the screen brightness reduction processing and the system lock processing described above, while when there is HID input, time counting will be stopped and reset if the Dim timer 332 or the Leave timer 335 is counting the time, and if the screen brightness is changed to the low brightness, the screen brightness will be restored to the standard brightness.

The system processing unit 310 is a functional component implemented by the CPU 301 executing the BIOS and OS programs or programs running on the OS. For example, the system processing unit 310 includes an operation control unit 311, an OS timer (Sleep timer) 312, a display control unit 313, and a system authentication unit 314 as functional components implemented by executing the OS program.

The operation control unit 311 controls the operating state of the system. For example, when the power button 140 is operated in the standby state, the operation control unit 311 boots the system from the standby state based on an operation signal acquired from the power button 140 through the EC 200. Further, in the normal operating state, the operation control unit 311 performs processing such as system shutdown, the transition to the standby state, reboot, or the like based on an operation on an OS power menu (shutdown, sleep, reboot, or the like) displayed in the display unit 110.

Further, the operation control unit 311 controls the operating state of the system according to the HPD processing executed by the HPD processing unit 330 based on the detection results by the face detection unit 210. For example, when the standby state transition instruction is acquired from the HPD processing unit 320 in the normal operating state, the operation control unit 311 gives a screen-off instruction to the display control unit 313 to turn off the screen, and then locks the system to make the transition to the standby state.

Further, in a state where no HID input is detected, the operation control unit 311 uses the OS timer 312 to count time TS until the transition of the system to the standby state is made. Then, when the time TS has passed without detecting HID input, the operation control unit 311 gives the screen-off instruction to the display control unit 313 to turn off the screen, and then locks the system to make the transition to the standby state.

Note that when HID input is detected before the time TS passes, the operation control unit 311 stops the counting of the OS timer 312 and resets the OS timer 312, and continues the normal operating state without making the transition to the standby state.

The OS timer 312 is a timer for counting the time TS (for example, 30 seconds to 5 minutes) until the transition to the standby state is made when the state of not detecting HID input continues. For example, the OS timer 312 is reset every time HID input is detected, and starts counting the time TS (from the point of the last HID input in time) when HID input is not detected. When the counting of the time TS by the OS timer 312 is completed, the operation control unit 311 gives the screen-off instruction to the display control unit 313, and locks the system to make the transition to the standby state.

The display control unit 313 performs control to turn on and turn off the display of the display unit 110. For example, when acquiring the screen-off instruction from the operation control unit 311, the display control unit 313 controls the display unit 110 to turn off the display, that is, to turn off the screen.

Further, the display control unit 313 controls the screen brightness of the display unit 110 in the display-on state. Specifically, the display control unit 313 controls the screen brightness of the display unit 110 based on the brightness setting value stored in the storage unit 170. This brightness setting value is initially set in the system, and the user can also change the brightness setting value from the initial setting according to the usage environment and user preference. Further, this brightness setting value is changed by the screen brightness changing unit 331 of the HPD processing unit 320.

When an user authentication event occurs at the time of logging into the system or unlocking from the locked state, the system authentication unit 314 executes authentication processing to authenticate whether or not the person is the authorized user. For example, the system authentication unit 314 executes authentication processing by any of face authentication, password authentication, PIN authentication, and fingerprint authentication.

For example, when authentication processing by face authentication is executed upon system user authentication, the system authentication unit 314 performs face authentication processing (second face authentication processing) by checking a face image (second face image) detected from among captured images (IR image +RGB image), captured by using the IR camera and the RGB camera of the imaging unit 120, with a face image of the authorized user (face image for second authentication) registered in advance as the system user information (account information). When the authentication result of the second face authentication processing is authentication success, the system authentication unit 314 determines that the person is the authorized user, while in the case of authentication failure, the system authentication unit 314 determines that the person is not the authorized user. Then, the system authentication unit 314 outputs, to the system processing unit 310, the authentication result upon system user authentication (the authentication result of the second face authentication processing).

Note that the face image of the authorized user (face image for second authentication) registered as the system user information (account information) is a face image of the authorized user detected from among captured images (IR image+RGB image) captured by using the IR camera and the RGB camera of the imaging unit 120, for example, in a system-set image registration menu for face authentication.

Thus, the second face image used at the time of system user authentication is a face image different in condition from the first face image used at the time of user authentication in the HPD processing. For example, the first face image and the second face image are different in imaging condition as described above, that is, the first face image is a face image detected from the RGB image, and the second face image is a face image detected from among the IR image and the RGB image.

Note that upon system user authentication (for example, login authentication), the system authentication unit 314 may also execute authentication processing using a face image detected from a captured image (IR image or RGB image) captured by using either one of the IR camera and the RGB camera of the imaging unit 120 (for example, using only the IR camera).

Further, in the case of password authentication or PIN authentication, the system authentication unit 314 acquires, through the EC 200, an operation signal based on user operations on the keyboard 151. Then, based on the acquired operation signal, the system authentication unit 314 executes authentication processing by checking the password or PIN input by the user operations with a password or PIN registered in advance. Further, in the case of fingerprint authentication, the system authentication unit 314 executes authentication processing by checking a fingerprint acquired using an unillustrated fingerprint sensor with a fingerprint registered in advance.

Note that the Dim timer 332, the Leave timer 335, and the OS timer 312 described above operate separately.

### Operation of Screen Brightness Reduction Processing

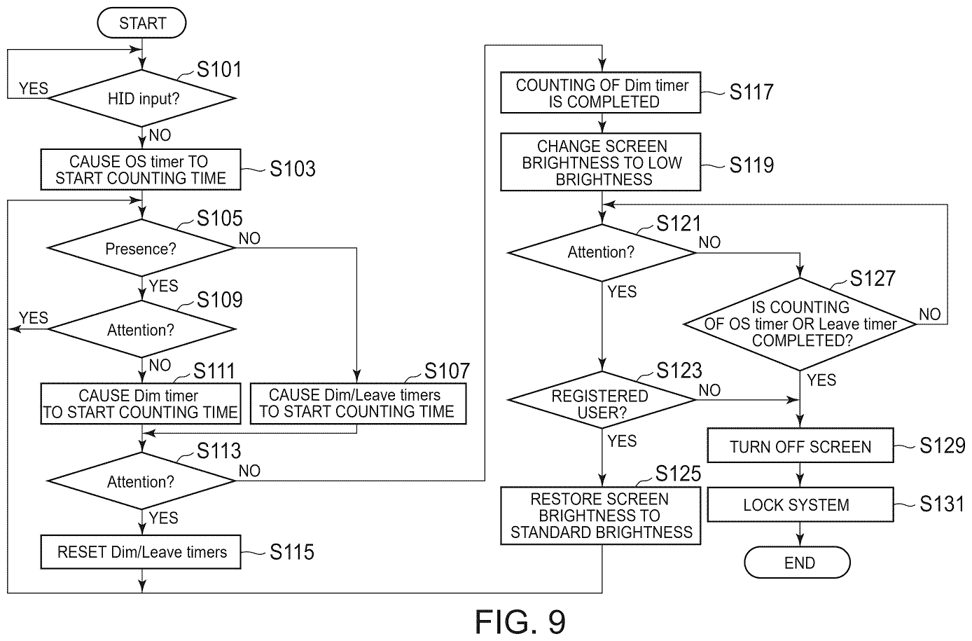

Referring next to FIG. 9, the operation of the screen brightness reduction processing and the system lock processing described above will be described. FIG. 9 is a flowchart illustrating an example of the screen brightness reduction processing and the system lock processing according to one or more embodiments. Here, it is assumed that the information processing apparatus 1 is in the state of “Presence” and “Attention” in the normal operating state, and the screen brightness of the display unit 110 is controlled to the standard brightness.
(Step S101) The HPD processing unit 330 determines whether or not there is HID input. When determining that there is HID input (YES), the HPD processing unit 330 performs the process in step S101 again. On the other hand, when determining that there is no HID input (NO), the procedure proceeds to a process in step S103.
(Step S103) When it is determined that there is no HID input in step S101, the system processing unit 310 causes the OS timer 312 to start counting time. Then, the procedure proceeds to a process in step S105.
(Step S105) The HPD processing unit 330 determines whether or not the “Presence” information is acquired from the face detection unit 210. When determining that the “Presence” information is not acquired (NO), the HPD processing unit 330 proceeds to a process in step S107. On the other hand, when determining that the “Presence” information is detected (YES), the HPD processing unit 330 proceeds to a process in step S109.
(Step S107) The HPD processing unit 330 causes the Dim timer 332 and the Leave timer 335 to start counting time. Then, the HPD processing unit 330 proceeds to a process in step S113.
(Step S109) The HPD processing unit 330 determines whether or not the “Attention” information is acquired from the face detection unit 210. When determining that the “Attention” information is acquired (YES), the HPD processing unit 330 returns to the process in step S105. On the other hand, when determining that the “Attention” information is not acquired (NO), the HPD processing unit 330 proceeds to a process in step S111.
(Step S111) The HPD processing unit 330 causes the Dim timer 332 to start counting time. Then, the HPD processing unit 330 proceeds to a process in step S113.
(Step S113) The HPD processing unit 330 determines whether or not the “Attention” information is acquired from the face detection unit 210. When determining that the “Attention” information is acquired (YES), the HPD processing unit 330 proceeds to a process in step S115. On the other hand, when determining that the “Attention” information is not acquired (NO), the HPD processing unit 330 proceeds to a process in step S117.

(Step S115) The HPD processing unit 330 stops the counting of the Dim timer 332 and the Leave timer 335 to reset the Dim timer 332 and the Leave timer 335, and returns to the process in step S105.

(Step S117) When the counting of the Dim timer 332 is completed, the HPD processing unit 330 proceeds to a process in step S119.

(Step S119) The HPD processing unit 330 changes the screen brightness of the display unit 110 from the standard brightness to the low brightness. Then, the HPD processing unit 330 proceeds to a process in step S121.
(Step S121) The HPD processing unit 330 determines whether or not the “Attention” information is acquired from the face detection unit 210. When determining that the “Attention” information is acquired (YES), that is, when determining that there is a person paying attention to the display unit 110, the HPD processing unit 330 proceeds to a process in step S123. On the other hand, when determining that the “Attention” information is not acquired (NO), the HPD processing unit 330 proceeds to a process in step S127.
(Step S123) The HPD processing unit 330 determines whether or not the person paying attention to the display unit 110 is a registered user (that is, the authorized user) based on the authentication result by the face detection unit 210. When determining that the person is not the registered user (NO), the HPD processing unit 330 proceeds to a process in step S129. On the other hand, when determining that the person is the registered user (YES), the HPD processing unit 330 proceeds to a process in step S125.
(Step S125) The HPD processing unit 330 restores the screen brightness of the display unit 110 from the low brightness to the standard brightness. Then, the HPD processing unit 330 returns to the process in step S105.
(Step S127) The HPD processing unit 330 determines whether or not the counting of the OS timer 312 or the Leave timer 335 is completed. When determining that the counting of both of the OS timer 312 and Leave timer 335 is not completed (NO), the HPD processing unit 330 returns to the process in step S121. On the other hand, when determining that the counting of the OS timer 312 or the Leave timer 335 is completed (YES), the HPD processing unit 330 proceeds to the process in step S129.
(Step S129) The HPD processing unit 330 outputs, to the system processing unit 310, the standby state transition instruction to lock the system. When acquiring the standby state transition instruction from the HPD processing unit 330, the system processing unit 310 controls the display unit 110 to turn off the display in order to turn off the screen. Then, the procedure proceeds to a process in step S131.
(Step S131) The system processing unit 310 locks the system to make the transition to the standby state. After that, when the information processing apparatus 1 is used, it is necessary to unlock the system by user authentication.

### Summary of Embodiments

As described above, the information processing apparatus 1 according to one or more embodiments includes: a memory (for example, the system memory 304) which temporarily stores a program of the system (for example, the OS); a first processor (for example, the CPU 301, the chipset 303, and the like) which controls the operation of the system by executing the program of the system; and a second processor (for example, the face detection unit 210) which performs detection processing to detect a person present in a direction to face the display unit 110 and to detect whether or not the person is paying attention to the display unit 110 based on a captured image captured by the imaging unit 120, and face authentication processing (for example, the first face authentication processing) to check a face image of the person present in the direction to face the display unit 110 with a face image of the user registered in advance (for example, first face image). When the presence of the person paying attention to the display unit 110 is no longer detected from a state where the presence of the person is detected by the detection processing mentioned above, the information processing apparatus 1 performs power reduction processing to make a transition to the low power mode. After the transition to the low power mode, when the presence of a person paying attention to the display unit 110 is detected, the information processing apparatus 1 performs determination processing to determine whether or not the person is the user registered in advance based on the authentication result by the face authentication processing (for example, the first face authentication processing). When the presence of the person paying attention to the display unit 110 is detected and the person is determined to be the user registered in advance after the transition to the low power mode, the information processing apparatus 1 performs power restoration processing to restore the power mode from the low power mode. When the presence of the person paying attention to the display unit 110 is detected and the person is determined not to be the user registered in advance after the transition to the low power mode, the information processing apparatus 1 performs lock processing to lock the system.

Thus, since the information processing apparatus 1 can realize both power saving and security ensuring in the absence for a short period of time, even in a case where the time (timer) from when the absence of the person is detected until the system is locked is set long, security is ensured until the system is locked. Therefore, the information processing apparatus 1 can control the system not to lock the system in the case of the absence of the person (for example, the authorized user) for a short period of time while ensuring security.

The low power mode mentioned above is, for example, an operating mode in which the screen brightness of the display unit 110 is reduced. For example, when the presence of the person paying attention to the display unit 110 is no longer detected from the state where the presence of the person is detected, the information processing apparatus 1 performs screen brightness reduction processing to reduce the screen brightness of the display unit 110 (to change the screen brightness from the standard brightness to the low brightness) as the power reduction processing mentioned above.

Thus, the information processing apparatus 1 can save power by reducing the screen brightness in the case of the absence for a short period of time.

Further, after locking the system, the information processing apparatus 1 performs unlock processing to unlock the system on a condition that an authentication result by system authentication processing (for example, user authentication processing) to authenticate whether or not the person is the authorized user registered in advance in the system is authentication success.

Thus, the information processing apparatus 1 can ensure security though it takes time because user authentication for the system is required when using the information processing apparatus 1 next time after locking the system.

Further, in the lock processing to lock the system, in a case where the presence of the person paying attention to the display unit 110 is no longer detected in the direction to face the display unit 110 from the state where the presence of the person is detected, when the time TL (an example of a first time) has passed in the state where the presence of the person is not detected, the information processing apparatus 1 locks the system. Further, when the presence of the person paying attention to the display unit 110 is detected and the person is determined not to be the user registered in advance after the transition to the low power mode, the information processing apparatus 1 locks the system according to the fact that the detection and the determination are made without waiting for the time TL to pass.

Thus, when an unregistered user is detected while saving power due to the absence for a short period of time even in a state where the system is not locked, since the information processing apparatus 1 instantly locks the system, security until the system is locked can be ensured even if the time (timer) from when the absence of the person is detected until the system is locked is set long.

Further, in the power reduction processing (for example, the screen brightness reduction processing), in a case where the presence of the person paying attention to the display unit 110 is no longer detected from the state where the presence of the person is detected, when the time TD (an example of a second time) shorter than the time TL has passed in the state where the presence of the person paying attention to the display unit 110 is not detected, the information processing apparatus 1 makes the transition to the low power mode (for example, reduces the screen brightness).

Thus, when the person paying attention to the display unit 110 is not present, the information processing apparatus 1 can save power (for example, reduce the screen brightness) relatively quickly and hence can increase the effect of power saving. For example, even if reducing the screen brightness, since information processing apparatus 1 can restore the screen brightness instantly only by changing the screen brightness upon restoration without bothering the user, the time TD from when it is detected that the person paying attention to the display unit 110 is not present until saving power (for example, reducing the screen brightness) can be set short.

Further, in the lock processing to lock the system, when the time TS (an example of a third time) has passed in a state where HID input (input by the user) is not detected regardless of the transition to the low power mode, the information processing apparatus 1 locks the system. Further, when the presence of the person paying attention to the display unit 110 is detected and the person is determined not to be the user registered in advance after the transition to the low power mode, the information processing apparatus 1 locks the system according to the fact that the detection and the determination are made without waiting for the time TS to pass.

Thus, when an unregistered user is detected while saving power due to the absence for a short period of time even in the state where the system is not locked, since the information processing apparatus 1 locks the system instantly, security until the system is locked can be ensured even if the time (timer) until the information processing apparatus 1 locks the system (for example, the OS) by determining that the person is absent due to the fact that a non-operation state continues is set long.

Further, in the power reduction processing (for example, the screen brightness reduction processing), in the case where the presence of the person paying attention to the display unit 110 is no longer detected from the state where the presence of the person is detected, when the time TD (the example of the second time) shorter than the time TS has passed in the state where the presence of the person paying attention to the display unit 110 is not detected, the information processing apparatus 1 makes the transition to the low power mode (for example, reduces the screen brightness).

Thus, when the person paying attention to the display unit 110 is not present, the information processing apparatus 1 can save power (for example, reduce the screen brightness) relatively quickly and hence can increase the effect of power saving. For example, even if reducing the screen brightness, since information processing apparatus 1 can restore the screen brightness instantly only by changing the screen brightness upon restoration without bothering the user, the time TD from when it is detected that the person paying attention to the display unit 110 is not present until saving power (for example, reducing the screen brightness) can be set short.

Further, a control method according to one or more embodiments is a control method for the information processing apparatus 1 including: a memory (for example, the system memory 304) which temporarily stores a program of the system (for example, the OS); a first processor (for example, the CPU 301, the chipset 303, and the like) which controls the operation of the system by executing the program of the system; and a second processor (for example, the face detection unit 210) which performs detection processing to detect a person present in a direction to face the display unit 110 and to detect whether or not the person is paying attention to the display unit 110 based on a captured image captured by the imaging unit 120, and face authentication processing to check a face image of the person present in the direction to face the display unit 110 with a face image of the user registered in advance, the control method including:
a step of causing the first processor to make a transition to the low power mode when the presence of the person paying attention to the display unit 110 is no longer detected from the presence of the person is detected by the detection processing mentioned above; a step in which, after the transition to the low power mode, when the presence of a person paying attention to the display unit 110 is detected, the first processor determines whether or not the person is a user registered in advance based on an authentication result by the face authentication processing; a step in which, after the transition to the low power mode, when the presence of a person paying attention to the display unit 110 is detected and the person is determined to be the user registered in advance, the first processor restores a power mode from the low power mode; and a step in which, after the transition to the low power mode, when the presence of a person paying attention to the display unit 110 is detected and the person is determined not to be the user registered in advance, the first processor locks the system.

Thus, since the control method for the information processing apparatus 1 can realize both power saving and security ensuring in the absence for a short period of time, even in a case where the time (timer) from when the absence of the person is detected until the system is locked is set long, security is ensured until the system is locked. Therefore, the control method for the information processing apparatus 1 can control the system not to lock the system in the absence of the person (for example, the authorized user) for a short period of time while ensuring security.

Further, the information processing apparatus 1 according to one or more embodiments includes: a memory (for example, the system memory 304) which temporarily stores a program of the system (for example, the OS); a first processor (for example, the CPU 301, the chipset 303, and the like) which controls the operation of the system by executing the program of the system; and a second processor (for example, the face detection unit 210) which performs detection processing to detect a person present in a direction to face the display unit 110 based on captured images captured by the imaging unit 120. The information processing apparatus 1 performs first face authentication processing to check a first face image of the person present in the direction to face the display unit 110 with a face image for first authentication of the user registered in advance. Further, when the presence of the person is detected in the direction to face the display unit 110 by the detection processing mentioned above and the person is determined not to be the user registered in advance by the first face authentication processing, the information processing apparatus 1 performs lock processing to lock the system. Further, the information processing apparatus 1 performs second face authentication processing to check a second face image of the person present in the direction to face the display unit 110, acquired based on a captured image captured by the imaging unit 120 under a condition different from that of the first face image, with a face image for second authentication of the user registered in advance. Then, when the person is determined to be the user registered in advance by the second face authentication processing, the information processing apparatus 1 performs unlock processing to unlock the system.

In other words, the information processing apparatus 1 includes two types of face authentication processing to check the person in terms of two types of face images (for example, the first face image and the second face image of the same user under different imaging conditions), respectively, and when the person present in the direction to face the display unit 110 is determined not to be the user registered in advance by using the first face authentication processing, the information processing apparatus 1 locks the system, while when the person present in the direction to face the display unit 110 is determined to be the user registered in advance by using the second face authentication processing, the information processing apparatus 1 unlocks the system. Thus, since the information processing apparatus 1 can control the system between locking and unlocking of the system properly depending on the situation such as the operating state of the system, the presence of the person, and the like, the information processing apparatus 1 can lock or not lock the system depending on the situation while ensuring security.

Further, a control method according to one or more embodiments is a control method for the information processing apparatus 1 including: a memory (for example, the system memory 304) which temporarily stores a program of the system (for example, the OS); a first processor (for example, the CPU 301, the chipset 303, and the like) which controls the operation of the system by executing the program of the system; and a second processor (for example, the face detection unit 210) which performs detection processing to detect a person present in a direction to face the display unit 110 based on captured images captured by the imaging unit 120, the control method including: a first face authentication step of causing the second processor to check a first face image of the person present in the direction to face the display unit 110 with a face image for first authentication of the user registered in advance; a step of causing the first processor to lock the system when the presence of the person is detected in the direction to face the display unit 110 by the detection processing mentioned above and the person is determined not to be the user registered in advance by the first face authentication step; a second face authentication step of causing the first processor to check a second face image of the person present in the direction to face the display unit 110, acquired based on a captured image captured by the imaging unit 120 under a condition different from that of the first face image, with a face image for second authentication of the user registered in advance; and a step of causing the first processor to unlock the system when the person is determined to be the user registered in advance by the second face authentication step.

In other words, the control method for the information processing apparatus 1 includes two types of face authentication steps to check the person in terms of two types of face images (for example, the first face image and the second face image of the same user under different imaging conditions), respectively, and when the person present in the direction to face the display unit 110 is determined not to be the user registered in advance by using the first face authentication step, and a step of causing the first processor to unlock the system when the person is determined to be the user registered in advance by using the second face authentication step. Thus, since the control method for the information processing apparatus 1 can control the system between locking and unlocking of the system properly depending on the situation such as the operating state of the system, the presence of the person, and the like, the control method for the information processing apparatus 1 can lock or not lock the system depending on the situation while ensuring security.

While embodiments of this invention have been described in detail above with reference to the accompanying drawings, the specific configurations are not limited to those described above, and design changes and the like are included without departing from the scope of this invention. For example, the respective components described in the embodiments described above can be combined arbitrarily.

Note that the example of power saving by reducing the screen brightness of the display unit 110 as the low power mode is described in one or more embodiments, but the method of power saving is not limited to this example, and any other power saving method can be applied. For example, power may be saved by decreasing the display refresh rate of the display unit 110. Further, when the touch panel for accepting touch operations on the display screen is provided in the display unit 110, power may be saved by turning off the touch panel.

Further, the configuration example in which the imaging unit 120 is built in the information processing apparatus 1 is described, but the configuration is not limited to this example. For example, the imaging unit 120 does not have to be built in the information processing apparatus 1, which may also be attachable to the information processing apparatus 1 (for example, onto any one of the side faces 10a, 10b, 10c, and the like) and communicably connected to the information processing apparatus 1 wirelessly or by wire as an external accessory of the information processing apparatus 1.

Further, in one or more embodiments, the example in which the face detection unit 210 is provided separately from the CPU 301 and the chipset 303 is described, but some or all of the functions of the face detection unit 210 may be provided in the chipset 303, or may be provided in a processor integrated with the CPU 301 or the chipset 303. For example, the CPU 301, the chipset 303, and the face detection unit 210 may be configured as individual processors, respectively, or configured to be integrated as one processor. Further, some or all of the functions of the face detection unit 210 may be provided in the EC 200.

Further, a hibernation state, a power-off state, and the like may be included as the standby state described above. The hibernation state corresponds, for example, to S4 state defined in the ACPI specification. The power-off state corresponds, for example, to S5 state (shutdown state) defined in the ACPI specification. Note that the standby state, the sleep state, the hibernation state, the power-off state, and the like as the standby state are states lower in power consumption than the normal operating state (states of reducing power consumption).

Note that the information processing apparatus 1 described above has a computer system therein. Then, a program for implementing the function of each component included in the information processing apparatus 1 described above may be recorded on a computer-readable recording medium so that the program recorded on this recording medium is read into the computer system and executed to perform processing in each component included in the information processing apparatus 1 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a portable medium such as a flexible disk, a magneto-optical disk, a flash ROM, or a CD-ROM, or a storage device such as a hard disk built in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be split into plural pieces, downloaded at different timings, respectively, and then united in each component included in the information processing apparatus 1, or delivery servers for delivering respective split pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called a differential file (differential program) capable of implementing the above-described functions in combination with a program(s) already recorded in the computer system.

Further, some or all of the functions of the information processing apparatus 1 in one or more embodiments described above may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Further, the information processing apparatus 1 of one or more embodiments is not limited to the laptop PC, which may also be a desktop PC or the like, for example.

### DESCRIPTION OF SYMBOLS

1 information processing apparatus
10 first chassis
20 second chassis
15 hinge mechanism
110 display unit
120 imaging unit
140 power button
150 input device
151 keyboard
153 touch pad
160 communication unit
170 storage unit
200 EC
210 face detection unit
211 detection processing unit
212 face authentication processing unit
300 main processing unit
301 CPU
302 GPU
303 chipset
304 system memory
310 system processing unit
311 operation control unit
312 OS timer
313 display control unit
314 system authentication unit
330 HPD processing unit
331 screen brightness changing unit
332 Dim timer
333 user determination unit
334 system operation instruction unit
335 Leave timer
336 HID input determination unit
400 power supply unit

What is claimed is:

1. An information processing apparatus comprising:
a memory which temporarily stores a program of a system;
a first processor which controls operation of the system by executing the program of the system; and
a second processor which performs detection processing to detect a person present in a direction to face a display unit and to detect whether or not the person is paying attention to the display unit based on a captured image captured by an imaging unit, and face authentication processing to check a face image of the person present in the direction to face the display unit with a face image of a user registered in advance,
wherein the first processor performs
power reduction processing in which, when presence of the person paying attention to the display unit is no longer detected from a state where the presence of the person is detected by the detection processing, the first processor makes a transition to a low power mode,
determination processing in which, after the transition to the low power mode, when the presence of a person paying attention to the display unit is detected by the detection processing, the first processor determines whether or not the person is the user registered in advance based on an authentication result by the face authentication processing,
power restoration processing in which, when the presence of the person paying attention to the display unit is detected by the detection processing and the person is determined to be the user registered in advance by the determination processing after the transition to the low power mode, the first processor restores a power mode from the low power mode, and
lock processing in which, when the presence of the person paying attention to the display unit is detected by the detection processing and the person is determined not to be the user registered in advance by the determination processing after the transition to the low power mode, the first processor locks the system.

2. The information processing apparatus according to claim 1, wherein after locking the system, the first processor performs unlock processing to unlock the system on a condition that an authentication result by system authentication processing to authenticate whether or not the person is an authorized user registered in advance in the system is authentication success.

3. The information processing apparatus according to claim 1, wherein
in the lock processing, in a case where the presence of the person paying attention to the display unit is no longer detected in the direction to face the display unit from the state where the presence of the person is detected by the detection processing, when a first time has passed in a state where the presence of the person is not detected, the first processor locks the system, and
after the transition to the low power mode, when the presence of a person paying attention to the display unit is detected by the detection processing and the person is determined not to be the user registered in advance by the determination processing, the first processor locks the system according to a fact that the detection and the determination are made without waiting for the first time to pass.

4. The information processing apparatus according to claim 3, wherein in the power reduction processing, in a case where the presence of the person paying attention to the display unit is no longer detected from the state where the presence of the person is detected by the detection processing, when a second time shorter than the first time has passed in the state where the presence of the person paying attention to the display unit is not detected, the first processor makes the transition to the low power mode.

5. The information processing apparatus according to claim 1, wherein
in the lock processing, when a third time has passed in a state where input by the user is not detected regardless of the transition to the low power mode, the first processor locks the system, and
when the presence of a person paying attention to the display unit is detected by the detection processing and the person is determined not to be the user registered in advance by the determination processing after the transition to the low power mode, the first processor locks the system according to the fact that the detection and the determination are made without waiting for the third time to pass.

6. The information processing apparatus according to claim 5, wherein in the power reduction processing, in the case where the presence of the person paying attention to the display unit is no longer detected from the state where the presence of the person is detected by the detection processing, when a second time shorter than the third time has passed in the state where the person paying attention to the display unit is not detected, the first processor makes the transition to the low power mode.

7. The information processing apparatus according to claim 1, wherein the low power mode is an operating mode in which screen brightness of the display unit is reduced.

8. An information processing apparatus comprising:
a memory which temporarily stores a program of a system;
a first processor which controls operation of the system by executing the program of the system; and
a second processor which performs detection processing to detect a person present in a direction to face a display unit based on captured images captured by an imaging unit, wherein
the second processor performs first face authentication processing to check a first face image of the person present in the direction to face the display unit with a face image for first authentication of a user registered in advance, and
the first processor performs
lock processing to lock the system when the presence of the person is detected in the direction to face the display unit by the detection processing and the person is determined not to be the user registered in advance by the first face authentication processing,
second face authentication processing to check a second face image of the person present in the direction to face the display unit, acquired based on a captured image captured by the imaging unit under a condition different from that of the first face image, with a face image for second authentication of the user registered in advance, and
unlock processing to unlock the system when the person is determined to be the user registered in advance by the second face authentication processing.

9. A control method for an information processing apparatus comprising: a memory which temporarily stores a program of a system; a first processor which controls operation of the system by executing the program of the system; and a second processor which performs detection processing to detect a person present in a direction to face a display unit and to detect whether or not the person is paying attention to the display unit based on a captured image captured by an imaging unit, and face authentication processing to check a face image of the person present in the direction to face the display unit with a face image of a user registered in advance, the control method causing the first processor to perform
a step of making a transition to a low power mode when presence of the person paying attention to the display unit is no longer detected from a state where the presence of the person is detected by the detection processing,
a step of determining whether or not a person paying attention to the display unit is a user registered in advance based on an authentication result by the face authentication processing when the person is detected by the detection processing after the transition to the low power mode,
a step of restoring a power mode from the low power mode when the presence of the person paying attention to the display unit is detected by the detection processing and the person is determined to be the user registered in advance after the transition to the low power mode, and
a step of locking the system when the presence of the person paying attention to the display unit is detected by the detection processing and the person is determined not to be the user registered in advance after the transition to the low power mode.

10. A control method for an information processing apparatus including a memory which temporarily stores a program of a system; a first processor which controls operation of the system by executing the program of the system; and a second processor which performs detection processing to detect a person present in a direction to face a display unit based on captured images captured by an imaging unit, the control method comprising:
a first face authentication step of causing the second processor to check a first face image of the person present in the direction to face the display unit with a face image for first authentication of a user registered in advance;
a step of causing the first processor to lock the system when the presence of the person is detected in the direction to face the display unit by the detection processing, and the person is determined not to be the user registered in advance by the first face authentication step;
a second face authentication step of causing the first processor to check a second face image of the person present in the direction to face the display unit, acquired based on a captured image captured by the imaging unit under a condition different from that of the first face image, with a face image for second authentication of the user registered in advance; and
a step of causing the first processor to unlock the system when the person is determined to be the user registered in advance by the second face authentication step.
